(19) United States
(12) Patent Application Publication
(10) Pub. No.: US 2025/0259138 A1
(43) Pub. Date: Aug. 14, 2025

(54) BAGGAGE AUTO-REFLIGHTING

(71) Applicant: SITA Information Networking Computing UK Limited, Hayes (GB)

(72) Inventors: Tupac BASTIDAS, Hayes (GB); Harold CLEMENTS, Hayes (GB)

(21) Appl. No.: 19/185,775

(22) Filed: Apr. 22, 2025

Related U.S. Application Data
(63) Continuation of application No. PCT/EP2023/079497, filed on Oct. 23, 2023.

(30) Foreign Application Priority Data
Oct. 25, 2022 (GB) 2215792.9
Oct. 25, 2022 (GB) 2215795.2

(51) Int. Cl. G06Q 10/0835; G06K 19/077; G06Q 10/0833

(52) U.S. Cl. CPC G06Q 10/08355; G06K 19/07758; G06Q 10/0833

(57) ABSTRACT

An item handling system for moving an item between an origin and a destination according to a first scheduled route which departs the origin at a first predetermined departure time is provided. The item handling system can determine whether the item has missed the first predetermined departure time of the first scheduled route; determine the destination for the item; determine a new, second, scheduled route between the origin and the determined destination wherein the second scheduled route departs the origin at a second predetermined time which is different from the first predetermined time; and process the item according to the second scheduled route. A method for moving an item between an origin and a destination according to a first scheduled route which departs the origin at a first predetermined departure time and a mobile device and user-accessible device for communicating with the item handling system are also provided.

### CROSS-REFERENCE TO RELATED APPLICATIONS

This application is a continuation application of international patent application PCT/EP2023/079497, filed on Oct. 23, 2023, and entitled “ITEM HANDLING SYSTEM AND METHOD,” which claims the benefit of, and priority to, GB App No. 2215792.9, filed on Oct. 25, 2022; and GB App No. 2215795.2, filed on Oct. 25, 2022, the contents of which are each hereby incorporated by reference in their entireties as if set forth herein.

### FIELD OF THE INVENTION

This invention relates to item handling and tracking methods and systems. It is particularly, but not exclusively, concerned with baggage handling methods and systems, for example operating at airports, seaports, train stations, other transportation hubs or travel termini.

### BACKGROUND OF THE INVENTION

As the volume of items being transported globally continuously increases, with the Air Transport Industry alone transporting over 4 billion bags annually, handling and tracking items are becoming increasingly challenging. In particular, despite the advances in baggage handling and tracking technologies in recent years, the number of mishandled bags still remains high. For example, according to SITA's 2019 report, over 28 million bags were mishandled in the year of 2018.

In order to reduce the number of mishandled bags (e.g. delayed, damaged, or misplaced bags), various item handling and tracking solutions for reducing the number of mishandled bags have been developed and deployed in recent years. However, even with the state-of-the art solutions for reducing mishandling of bags and the highest level of care, there are still likely to be mishandled items due to unforeseen factors. It is therefore important to provide a post-mishandling solution to minimize the impact of the mishandling, such as severe delays in eventual delivery of the mishandled items. In view of that such delays may, in turn, increase the chance of the items being lost or damaged, providing a method and a system that can quickly identify and re-route mishandled items is essential for reducing losses for both the party responsible for handling items and the owners of the items.

We have appreciated that existing solutions for handling mishandled items, particularly when mishandling of the bags caused items to miss their original departure journey (e.g. departure flight) from the origin, involve additional steps, and in some cases, transfer of items to multiple locations prior to re-routing of the items. These additional steps often require manual intervention by human operators, which can lead to a further delay of the eventual delivery of the items. Although this problem has been explained in the context of baggage handling it applicable to any logistics process in a hub-and-spoke model, involving the transfer of an item (such as cargo, parcel or mail) which has to go through consecutive tasks with checkpoints and where the items may be at risk of not being delivered to the destination on time.

### SUMMARY OF THE INVENTION

According to a number of embodiments, the present disclosure relates to an item handling system for moving an item between an origin and a destination according to a first scheduled route which departs the origin at a first predetermined departure time. The system comprises processing means configured to: determine whether the item has missed or is expected to miss the first predetermined departure time of the first scheduled route; determine the destination for the item; determine a new, second, scheduled route between the origin and the determined destination wherein the second scheduled route departs the origin at a second predetermined time which is different from the first predetermined time; and process the item according to the second scheduled route.

The second predetermined time may be after or before the first predetermined time.

Optionally, the item handling system may comprise: storage means for storing first itinerary data associated with item, the first itinerary data comprising: the origin, the destination, the first predetermined departure time, and a physical path between the origin and destination according to the first scheduled route; and reading means for reading a tracking means associated with the item, the tracking means being attachable to the item and having a machine-readable element, wherein reading the machine-readable element via the reading means allows the processing means to access the storage means in order to: retrieve the first itinerary data of the item to determine the item has missed or is expected to miss the first predetermined departure time of the first scheduled route, and if the item has missed or is expected to miss the first predetermined departure time of the first scheduled route, add second itinerary data relating to the determined second scheduled route, the second itinerary data comprising: the second predetermined departure time and a physical path between the origin and destination according to the second scheduled route.

Optionally, the machine-readable element may be read via the reading means, the reading means generates item location data comprising a location and a time of the reading; and the item location data and live departure data at the origin may be monitored by the processing means to determine if the item missed the first predetermined departure time of the first scheduled route.

Optionally, the tracking means may be in the form of one or more of: a bag tag, a sticker label, and an RFID tag.

Optionally, the storage means is a remote storage, and preferably a cloud-based storage. Optionally, the second scheduled route may have a physical path that may be different from that of the first scheduled route.

Optionally, if the item has missed or is expected to miss the first predetermined departure time of the first scheduled route, the item may depart from a second departing point within the origin that is different from a first departing point within the origin according to the first scheduled route.

Optionally, the item handling system may comprise one or more conveyor systems for routing the item, wherein the item is re-routed at least partially by at least one of the conveyor systems to the second departing point.

Optionally, the re-routing may be performed without replacing or making physical modification to the tracking means associated with the item.

Optionally, an arrival time at the destination based on the second scheduled route may be transmitted to one or more user-accessible devices or systems at the destination.

Optionally, the item handling system may comprise a notification system for sending a message to a portable device of a passenger associated with the item, wherein a notification is sent to the portable device of the passenger if the processing means: determines that the item has missed or is expected to miss the first predetermined departure time of the first scheduled route; and/or the second scheduled route has been determined.

Optionally, the notification may comprise an arrival time at the destination based on the second scheduled route.

Optionally, the item, after arriving at the destination, may be further re-routed to a second destination.

Optionally, the processing means may receive details relating to the second destination for the further re-routing from a passenger associated with the item.

Optionally, the processing means may be configured to receive messages relating to one or more factors that caused the item to miss the first predetermined departure time of the first scheduled route and/or one or more parties that are responsible for the one or more factors.

Optionally, the item handling system may comprise a notification system for sending a message to one or more carriers and/or a portable device of a passenger associated with the item, wherein the notification system is configured to send a notification comprising details relating to the factors that caused the item to miss the first predetermined departure time of the first scheduled route.

Optionally, the second scheduled route between the origin and the determined destination may be determined based on one or more parameters comprising at least one of: preferred carrier, departing time, loading capacity, and distance between a current location of the item and a point of departure.

Optionally, the origin may be one of: an airport, a train station, a sea port, and a parcel handling hub.

According to a number of embodiments, the present disclosure relates to a mobile device for communicating with an item handling system for moving an item between an origin and a destination. If the item handling system determines that the item has been re-routed to a new, second, route to the destination that is different from an original, first, route to the destination, the mobile device is configured to receive a notification from the item handling system, the notification comprising details relating to the second route.

Optionally, the notification may comprise one or more of: a new departure time from the destination, a new arrival time at the destination, and a new physical path of the second route.

Optionally, the notification may comprise one or more factors that caused the item to be rerouted to the new route.

Optionally, the mobile device may be configured to receive a user input relating to a further destination for the item to be delivered.

According to a number of embodiments, the present disclosure relates to a user-accessible device for communicating with an item handling system for moving an item between an origin and a destination. If the item handling system determines that the item has been rerouted to a new, second, route to the destination that is different from an original, first, route to the destination, the user-accessible device is configured to: receive second itinerary data from the item handling system, the second itinerary data comprising details relating to the second route; and display the second itinerary data to a passenger associated with the item.

Optionally, the second itinerary data may comprise one or more of: a new departure time from the destination, a new arrival time at the destination, and a new physical path of the second route.

Optionally, the second itinerary data may comprise one or more factors that caused the item to be re-routed to the new route.

Optionally, the user-accessible device may be configured to receive a user input relating to a further destination for the item to be delivered.

Optionally, the user-accessible device may be located at the destination.

Optionally, the user-accessible device may be an electronic board or a kiosk.

According to a number of embodiments, the present disclosure relates to an item handling system for moving an item between an origin and a destination according to a first scheduled route which departs the origin at a first predetermined departure time. The system comprises: processing means; storage means; a reading means; and at least one conveyor system for conveying the item. The processing means is configured to: receive data associated with a tracking means associated with the item; retrieve a first itinerary data associated with the data associated with the tracking means; determine, based on the first itinerary data, if the item has missed or is expected to miss or is expected to miss a first predetermined departure time of the first scheduled route; if it is determined that the item has missed or is expected to miss the first predetermined departure time, determine a new, second, route between the origin and the destination; add second itinerary data relating to the determined second scheduled route to the storage means, the second itinerary data comprising: a second predetermined departure time, a departing point within the origin according to the second scheduled route, and a physical path between the origin and destination according to the first scheduled route; and control the at least one conveyor system to convey the item to the departing point.

According to a number of embodiments, the present disclosure relates to a method for moving an item between an origin and a destination according to a first scheduled route which departs the origin at a first predetermined departure time. The method comprises steps of: determining whether the item has missed or is expected to miss the first predetermined departure time of the first scheduled route; determining the destination for the item; determining a new, second, scheduled route between the origin and the determined destination wherein the second scheduled route departs the origin at a second predetermined time which is different from the first predetermined time; and processing the item according to the second scheduled route.

The second predetermined time may be after or before the first predetermined time.

According to a number of embodiments, the present disclosure relates to a method for moving an item between an origin and a destination according to a first scheduled route which departs the origin at a first predetermined departure time. The method comprises steps of: receiving data associated with a tracking means associated with the item; retrieving a first itinerary data associated with the data associated with the tracking means using the reading means; determining, based on the first itinerary data, if the item has missed or is expected to miss a first predetermined departure time of the first scheduled route; if it is determined that the item has missed or is expected to miss the first predetermined departure time, determining a new, second, route between the origin and the destination; adding second itinerary data relating to the determined second scheduled route to a storage means, the second itinerary data comprising: a second predetermined departure time, a departing point within the origin according to the second scheduled route, and a physical path between the origin and destination according to the first scheduled route; and controlling at least one conveyor system to convey the item to the departing point.

### BRIEF DESCRIPTION OF THE DRAWINGS

An embodiment of the invention will now be described, by way of example only, and with reference to the accompanying drawings, in which:

FIG. 1 is a schematic diagram of exemplary components of the item handling system according to an embodiment;

FIG. 2 is a schematic diagram of an exemplary process of handling baggage using the item handling system according to an embodiment;

FIG. 3 is a flow diagram of an exemplary process of performing a method for moving an item between an origin and a destination according to an embodiment;

FIG. 4 is a flow diagram of an exemplary process of performing a method for moving an item between an origin and a destination according to another embodiment;

FIG. 5 is a schematic diagram of an exemplary mobile device according to an embodiment; and

FIG. 6 is a schematic diagram of an exemplary user-accessible device according to an embodiment.

### DETAILED DESCRIPTION

The following exemplary description is based on a system, apparatus, and method for use in the aviation industry. However, it will be appreciated that the invention may find application outside the aviation industry and in any industry, such as in other travel industry, packaging or delivery industry, in which items such as bags, suitcases, packaged items, parcels, or mails are transported. Thus, embodiments of the invention find application in the travel industry in general, such as rail, coach, car, vessel, as well for delivery and courier services.

As used herein, the term “RUSH Baggage” means passenger's baggage which has not accompanied passengers on their booked flight/s and is directed to an alternative flight in order to be restored to that/those passengers.

When an item is mishandled at an origin, such as an origin airport, the mishandled item may miss a scheduled departure, such as a scheduled departure flight. Such mishandling may, for example, be caused by delayed arrival of the item at the origin, delayed handling of the item, item being damaged whilst handling the item, and the item being misplaced or lost. If, as a result of such mishandling, the item was not able to be loaded onto the scheduled departure flight, the item needs to be re-routed so that the item can reach a destination via an alternative route. As a result, the re-routed item will depart the origin on an alternative flight at a later departure time than the original departure time of the original flight. The physical path of the alternative route may be different from that of the original route. For example, the alternative route may comprise multiple legs with one or more intermediate points between the departure from the origin and the arrival at the destination.

In various existing solutions, re-routing of a mishandled item requires physically modifying a tracking means (e.g. a label, RFID tag or barcode) attached to the item or replacing it with a new tracking means. In other words, in order to re-route a mishandled item using the existing solutions, an original tracking means attached to the item, including original route information, needs to be replaced with a new or modified tracking means, including new route information. This is because the existing solutions rely on information displayed on tracking means for transporting items. However, the need for performing an additional step of replacing or modifying tracking means (e.g. re-labelling) inevitably means that the items need be transported to a suitable facility for replacing or modifying tracking means (e.g. relabeling station), or require a human operator to manually track the item to replace or modify the tracking means. The present invention, alongside other technical advantages it provides, provides a system and a method for re-routing mishandled items without the needs for replacing or modifying tracking means, thereby avoiding further delays and use of additional resources during the step of replacing or modifying tracking means.

The origin in the following exemplary description an airport. However, it will be appreciated that the origin in other embodiments may be one of: a train station, a seaport, and a parcel handling hub.

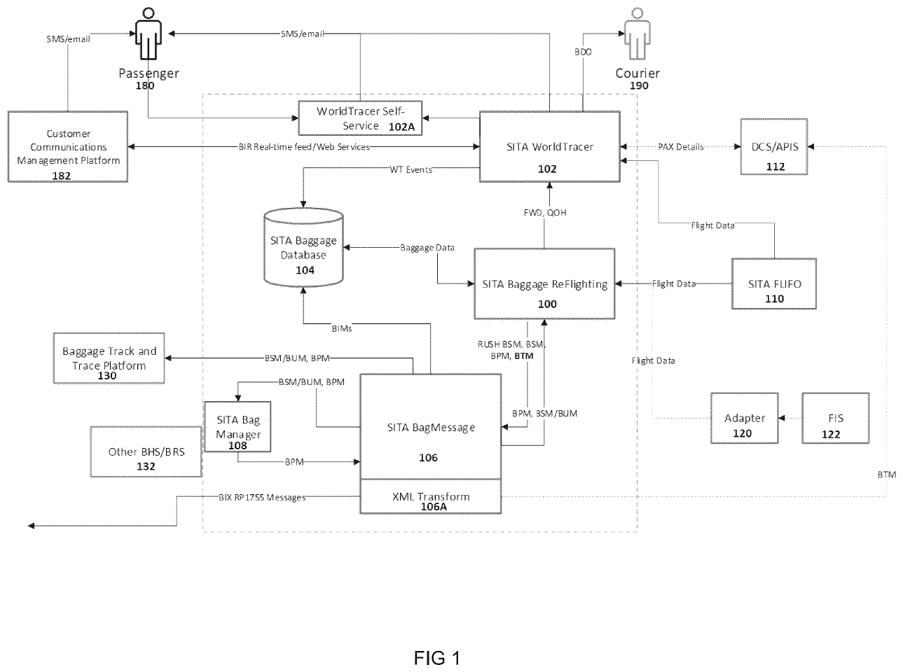

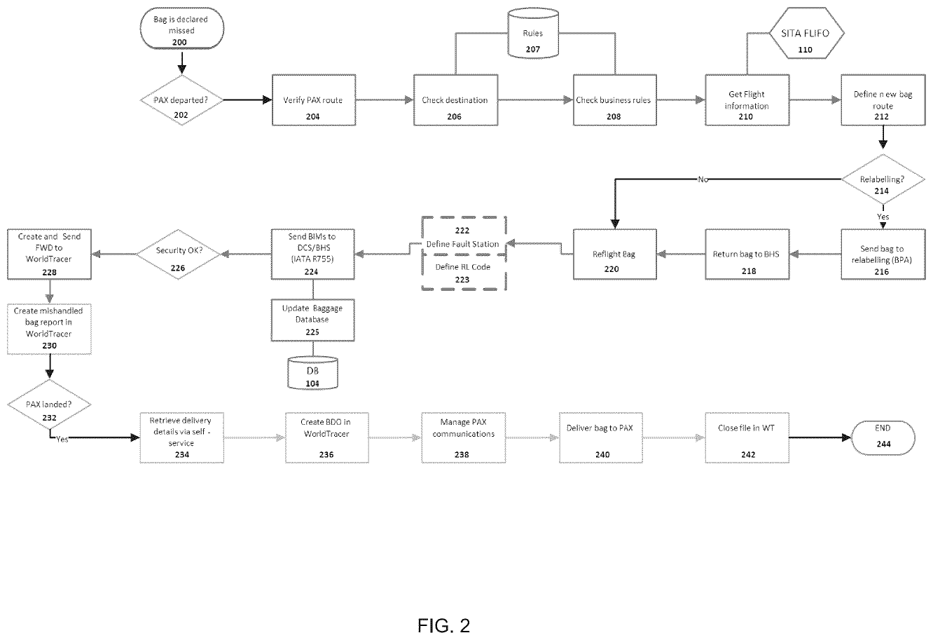

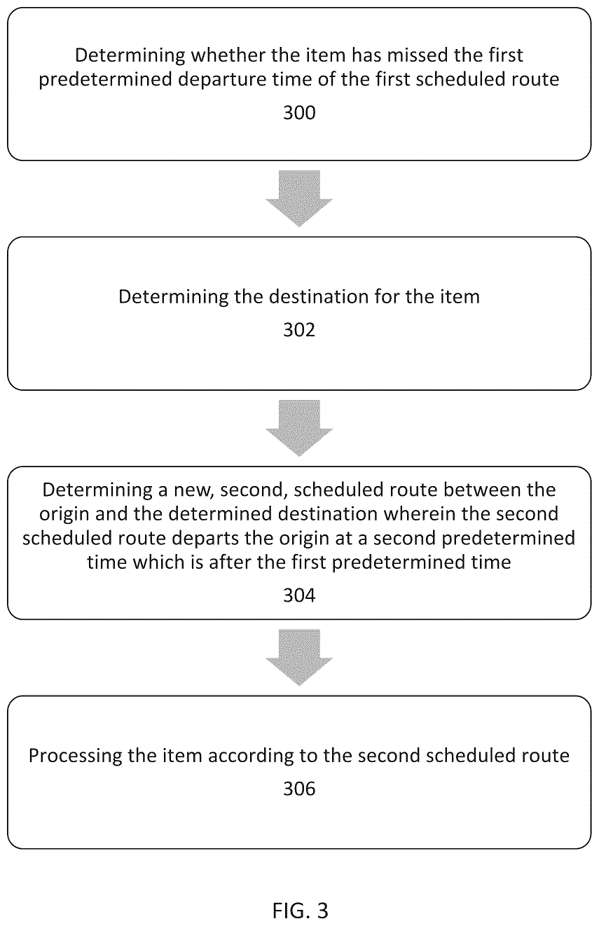

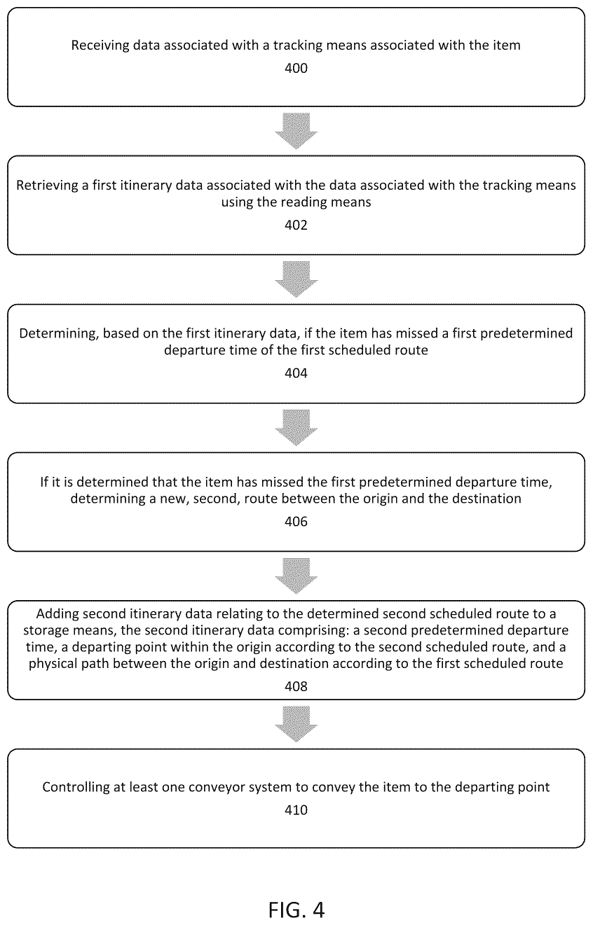

An embodiment of the invention will now be described referring to FIG. 1 illustrating the exemplary component diagram of an item handling system, and FIG. 2 illustrating an exemplary process diagram of handling an item using the item handling system. However, from the following description, it will be clear that embodiments of the invention may reside in any one of the components shown in FIG. 1 or as the item handling system as a whole. I will also be clear that the process illustrated in FIG. 2 is an example according to an embodiment, and in other embodiments some of the steps shown in FIG. 2 may be missing and/or be performed in different orders.

When an item is mishandled at an origin airport, the mishandling may often cause sufficient delay for the item to miss the originally scheduled departure. In some cases, if the origin airport is not the first point of the item's overall journey, such delay may be at least partly due to delayed arrival of the item at the origin airport. In some cases, such delays may at least partly due to one or more unforeseen events (e.g. natural disaster) other than mishandling of the item. If the item misses the originally scheduled departure to a destination for any of the aforementioned reasons, the item handling system according to the present invention can determine a new route to the destination and transport the item according to the new route.

The item handling system comprises a processing means that is configured to determine whether an item has missed its first predetermined departure time (i.e. the departure time according to the originally schedule) of the first scheduled route (i.e. the original route). The processing means may control one or more components of the item handling system. In the example item handling system illustrated in FIG. 1, the processing means controls a Baggage Re-Flighting Core module (100), Baggage Database module (104), and Bag Message module (106). Whether an item has missed its original departure flight may be determined based on baggage information stored in a Baggage Database (104). The Baggage Database (104) may retrieve such information from a message from a baggage handling system (BHS) that handled the item. In such cases, BHS may be equipped with or connected to suitable baggage tracking system that generates location logs of items being handled with corresponding timestamps. The baggage tracking system may, for example, track the item by using one or more suitable computer vision techniques and/or by retrieving information from a machine-readable element of the tracking means (e.g. a RFID chip, 2D barcode, QR code, or printed text for optical character reading (OCR)) attached to the item. The processing means may also compare the location history of the item and flight information database (110) to determine that bag has missed the original departure flight. For example, if baggage data indicates that the item is still at the origin airport after departure of the original departure flight, it may be determined that the item has missed the original departure flight.

As shown in FIG. 2, once it has been determined (200) that the item has missed the original departure flight, the processing means may optionally determine (202) whether a person associated with the item (e.g. a passenger who checked-in the item, or a person who is responsible for carrying or delivering the item to the destination) has departed the origin. For this, the processing means may identify the passenger associated with the item from the Baggage Database (104) and Advance Passenger Information System (APIS) (112), and retrieve boarding history of the passenger from a departure control system (DCS) (112).

Performing this step enables the item handling system to determine how the item should be re-routed. For example, in the case that the passenger who checked-in the item also missed the original departure flight, it may be beneficial to return the item to the passenger at the origin. Furthermore, in the case that the passenger decides to depart on an alternative flight, it may be beneficial to re-route the item to be loaded to the aircraft of the alternative flight.

If it has been determined that the passenger departed (202) the origin but the item missed (200) the original departure flight, the processing means then determines (206) a destination to which the item should be transported. In most cases, the destination to which the item should be transported will match the original destination of the item and the passenger. However, in the cases that the passenger departed the origin on a different flight having a different destination from that of the original departure flight, it may be beneficial to re-route the item to the said different destination. For this, the processing means may retrieve (204) flight details associated with the passenger and the boarding history of the passenger from APIS and DCS (112). Once the destination to which the item should be transported has been determined, the processing means determines (212) a new, second, scheduled route between the origin and the determined destination of the item. The new route may be determined (212) by taking into account various factors, such as baggage handling agreement between a plurality of carriers, load limits of alternative flights, preferred routes and preferred carriers.

The factors to be taken into account when determining the new route may be defined as rules (207) that can be configured by various users of the item handling system (e.g. airlines, couriers, passengers and airport).

The rules (207) may be configured to specify preferred airlines for re-routing mishandled items. For example, the rules (207) may be configured to specify that mishandled items should preferably be handled by the same airline as the airline of their original departure flights or by airlines in the same alliance. The preferred airlines may also be ranked in multiple tiers according to the degree of preference. The rules (207) may also be configured to avoid certain airlines (e.g. airlines that have no baggage handling agreement).

The rules (207) may also be configured to allow or disallow re-routing of mishandled items via non-direct routes (i.e. routes comprising multiple legs with one or more additional intermediate stops). In the cases that the rules (207) allow re-routing of mishandled items via non-direct routes, the rules (207) may further specify that direct routes are preferred over non-direct routes, and/or non-direct routes having fewer intermediate stop(s) are preferred over those having higher number of intermediate stops.

The rules (207) may also be configured to specify the maximum duration of the expected total journey time to the destination. In such cases, the rules (207) may further specify that routes having shorter expected total journey time(s) are preferred over those having longer expected total journey time.

If the rules (207) include multiple preferences, the preferences may be ranked in multiple tiers according to the degree of importance. In such cases, one or more preferences of lower tier(s) may be overruled in favor of one or more preferences of higher tier(s).

In some cases, one or more preferences specified in the rules (207) may be overruled based on one or more physical limitations. For example, if the most preferred flight according to the preferences specified in the rules (207) has reached or nearly reached its maximum load capacity, a less preferred flight having sufficient free capacity may need to be selected to avoid overloading or unsuccessful loading. Another example of such physical limitations is lead time to a loading point. In other words, if the most preferred flight according to the preferences specified in the rules (207) is likely to depart before the item can reach the loading point of the flight, a less preferred flight having a later departure time and/or a loading point located closer to the current location of the item may need to be selected to avoid unsuccessful loading.

Optionally, such physical limitations may be included in the rules (207).

In order to determine the new scheduled route between the origin and the determined destination of the item, the processing means retrieves (210) flight information of one or more candidate re-route flights from the flight information database (110). In the example shown in FIG. 2, this step is performed after the step of checking (208) the rules (207) for selecting re-route flights. However, in other embodiments, the item handling system may determine the new schedule route without take such rules (207) into account. In such cases, the next available flight to the destination may be selected as the new scheduled route.

Based on the retrieved flight information, and optionally the rules (207) specifying preferences for selecting a re-route flight (RUSH flight), the processing means determine the new scheduled route for the item to be re-routed.

In existing re-routing solutions, assigning a new route for an item and processing the item according to the new route requires re-labelling (214). In other words, re-routing using existing solutions requires an original tracking means (e.g. a label, RFID tag or barcode) attached to the item, including original route information, to be replaced with a new or modified tracking means, including new route information. This means that the items need be transported (216) to a suitable facility for replacing or modifying tracking means (e.g. relabeling station (BPA)), and then returned (218) to the baggage handling system (BHS) for processing. These additional steps lead to further delays and use of additional resources.

The item handling system according to the present invention, alongside other technical advantages it provides, provides a way to re-route (220) mishandled items without the needs for replacing or modifying tracking means. In order to enable this, the processing means may add (224, 225) second itinerary data relating to the new scheduled route to a storage means (104) storing first itinerary data associated with item. The first itinerary data includes the origin, the destination, the original departure time, and a physical path between the origin and destination according to the original scheduled route. The second itinerary data may include a new departure time according to the new scheduled route and a physical path between the origin and destination according to the new scheduled route.

As a result, the second itinerary data added to the storage means, as well as the first itinerary data, is associated with the original tracking means. This, in turn, enables the BHS to automatically transport the item according to the second itinerary data by reading the machine-readable element of the original tracking means. For example, if the RUSH flight departs from a new departing point within the origin that is different from that of the original flight, the BHS may transport the item from the original departing point to the new departing point.

Optionally, the first itinerary data that are different from the second itinerary data may be removed from the storage means (104). This reduces the storage space required to store itinerary data for re-routed bag.

Optionally, the BHS may comprise a plurality of reading means for automatically reading the machine-readable element of the tracking means so that the processing means can: retrieve the current location of the item; retrieve the location of the new departing point of the item; and control one or more conveyor systems of the BHS to automatically convey the item to the new departing point.

Optionally, the processing means may retrieve and check (226) information relating to any security requirement(s) to be met in order for the item to travel on the re-route flight (RUSH flight). Such information may be retrieved from one or more of: the carrier (e.g. airline) operating the RUSH flight, local authority of one or more of the destinations of the RUSH flight, and one or more of the destination passenger terminals (e.g. airport) of the RUSH flight. Such information may include requirement(s) and/or restriction(s) in relation to: contents of the item, weight of the item, dimensions of the item, origin of the item, destination of the item, airline rules, airport rules, and any required pre-approval status of the passenger and/or the item.

This step may be performed at any stage after the RUSH flight has been determined based on the rules (207) specifying preferences for selecting a RUSH flight, but before the item is loaded onto the aircraft of the RUSH flight. If the security requirement(s) indicate that the item is not allowed to travel on the determined RUSH flight, an alternative RUSH flight may be determined using the rules (207) specifying preferences for selecting a RUSH flight, in which case the item will be processed to be loaded onto the aircraft of the, new, alternative RUSH flight. If no such security requirement(s) exist or the security requirement(s) are met, the item is processed to the next stage for loading.

Alternatively, such security requirement(s) may be included in the rules (207) specifying preferences for selecting a RUSH flight, in which case a separate step for checking the security requirement(s) after determination of a RUSH flight may not be necessary.

Optionally, the item handling system may be configured to automatically identify one or more causes that lead to the item missing the original departure flight. Such investigation may be performed by investigating timestamped location history of the item, and/or flight information of one or more previous flights on which the item was transported to the origin. This may also enable identification of one or more parties at fault for the mishandling. For example, if the timestamped location history indicates that the item was checked-in later than a recommended latest check-in time, the party at fault would be the passenger. Similarly, if the flight information indicates that the pervious flight arrived at the origin leaving no or little time for the item to be conveyed to the departing point of the original flight, the airline that operated to previous flight may be the party at fault. If the timestamped location history indicates that the item had been stuck on a conveyor system, the operator or proprietor of the conveyor system may be the party at fault.

Consequently, the identified cause of delay (Reasons for Loss) (222) and party at fault (Fault Station) (223) may be saved in the storage means (104) and/or communicated to the passenger and/or the carrier in charge of handling the item.

As shown in FIG. 2, the updated itinerary data including the information relating to the new scheduled route may be forwarded (228) to a global baggage tracing and matching system (102). Based on the updated itinerary data, a mishandled bag report may also be generated (230) and saved in the global baggage tracing and matching system (102).

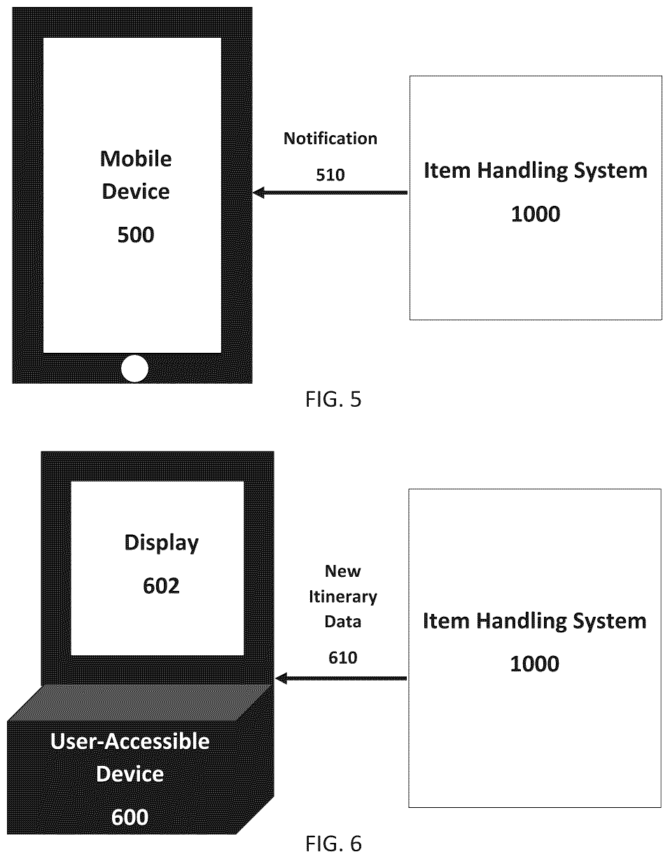

When the flight information (110) indicates that the passenger has arrived (232) at the destination, the passenger may be notified with details relating to the mishandling of the item and the second itinerary via the global baggage tracing and matching system (102). The details may, for example, include one or more of: notification that the item has missed the original departure flight; notification that the item has been re-routed; an arrival time at the destination based on the second scheduled route; the identified cause of mishandling (Reasons for Loss) (222); and the identified party at fault (Fault Station) (223). The passenger may be notified with such details by receiving a notification on their mobile (500) device as shown in FIG. 5. Alternatively, or additionally, the passenger may retrieve such details via a user-accessible device or system (600), as shown in FIG. 6, such as an electronic information board or a kiosk located at the destination. Alternatively, or additionally, the notification may be communicated to one or more mobile devices (500) and/or one or more user-accessible devices or systems (600) that are configured to be used by non-passenger users, such as airport and/or airline staff. Optionally, the user-accessible device or system (600) may be an interactive device or system that is accessible to both passenger users and non-passenger users, such as a kiosk.

As the re-routed item typically arrives at the destination later than the passenger, the passenger may prefer the item to be re-routed to a further destination (240), such as their temporary accommodation or home address. Therefore, the global baggage tracing and matching system (102) may create a Baggage Delivery Order (BDO) (236). Optionally, the item handling system may be configured so that such BDO is created only upon request by the passenger. In such cases, the passenger, or a non-passenger user on behalf of the passenger, may request a BDO to be created and, optionally, provide details relating to the further destination (e.g. the passenger's address) via a mobile device or a kiosk.

Communication between two or more components of the item handling system may be performed via one or more wired or/and wireless communication networks. One or more storage devices and/or systems that are part of or connected to the item handling system may be remote storage devices or systems, such as cloud-based storage devices or systems.

The wired or wireless communication networks described above may be public, private, wired or wireless network. The communications network may include one or more of a local area network (LAN), a wide area network (WAN), the Internet, a mobile telephony communication system, or a satellite communication system. The communications network may comprise any suitable infrastructure, including copper cables, optical cables or fibers, routers, firewalls, switches, gateway computers and edge servers.

The system described above may comprise a Graphical User Interface. Embodiments of the invention may include an on-screen graphical user interface. The user interface may be provided, for example, in the form of a widget embedded in a web site, as an application for a device, or on a dedicated landing web page. Computer readable program instructions for implementing the graphical user interface may be downloaded to the client device from a computer readable storage medium via a network, for example, the Internet, a local area network (LAN), a wide area network (WAN) and/or a wireless network. The instructions may be stored in a computer readable storage medium within the client device.

As will be appreciated by one of skill in the art, the invention described herein may be embodied in whole or in part as a method, a data processing system, or a computer program product including computer readable instructions. Accordingly, the invention may take the form of an entirely hardware embodiment or an embodiment combining software, hardware and any other suitable approach or apparatus.

The computer readable program instructions may be stored on a non-transitory, tangible computer readable medium. The computer readable storage medium may include one or more of an electronic storage device, a magnetic storage device, an optical storage device, an electromagnetic storage device, a semiconductor storage device, a portable computer disk, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk.

Exemplary embodiments of the invention may be implemented as a circuit board which may include a CPU, a bus, RAM, flash memory, one or more ports for operation of connected I/O apparatus such as printers, display, keypads, sensors and cameras, ROM, a communications sub-system such as a modem, and communications media.

1. An item handling system for moving an item between an origin and a destination according to a first scheduled route which departs the origin at a first predetermined departure time, wherein the system comprises:
a. processing means configured to:
i. determine whether the item has missed the first predetermined departure time of the first scheduled route;
ii. determine the destination for the item;
iii. determine a new, second, scheduled route between the origin and the determined destination wherein the second scheduled route departs the origin at a second predetermined time which is different from the first predetermined time; and
iv. process the item according to the second scheduled route.

2. The item handling system according to claim 1 comprising:
b. storage means for storing first itinerary data associated with item, the first itinerary data comprising: the origin, the destination, the first predetermined departure time, and a physical path between the origin and destination according to the first scheduled route; and
c. reading means for reading a tracking means associated with the item, the tracking means being attachable to the item and having a machine-readable element,
wherein reading the machine-readable element via the reading means allows the processing means to access the storage means in order to:
retrieve the first itinerary data of the item to determine the item has missed the first predetermined departure time of the first scheduled route, and
if the item has missed the first predetermined departure time of the first scheduled route, add second itinerary data relating to the determined second scheduled route, the second itinerary data comprising: the second predetermined departure time and a physical path between the origin and destination according to the second scheduled route.

3. The item handling system according to claim 2 wherein when the machine-readable element is read via the reading means, the reading means generates item location data comprising a location and a time of the reading; and
the item location data and live departure data at the origin are monitored by the processing means to determine if the item missed the first predetermined departure time of the first scheduled route.

4. The item handling system according to claim 2 or 3 wherein the tracking means is in the form of one or more of: a bag tag, a sticker label, and an RFID tag.

5. The item handling system according to claims 2 to 4 wherein the storage means is a remote storage, and preferably a cloud-based storage.

6. The item handling system according to any preceding claim wherein, the second scheduled route has a physical path that is different from that of the first scheduled route.

7. The item handling system according to any preceding claim wherein, if the item has missed the first predetermined departure time of the first scheduled route, the item departs from a second departing point within the origin that is different from a first departing point within the origin according to the first scheduled route.

8. The item handling system according to claim 7 comprising one or more conveyor systems for routing the item, wherein the item is re-routed at least partially by at least one of the conveyor systems to the second departing point.

9. The item handling system according to claim 8 wherein the re-routing is performed without replacing or making physical modification to the tracking means associated with the item.

10. The item handling system according to any preceding claim wherein an arrival time at the destination based on the second scheduled route is transmitted to one or more user-accessible devices or systems at the destination.

11. The item handling system according to any preceding claim comprising a notification system for sending a message to a portable device of a passenger associated with the item, wherein a notification is sent to the portable device of the passenger if the processing means:
determines that the item has missed the first predetermined departure time of the first scheduled route; and/or
the second scheduled route has been determined.

12. The item handling system according to claim 1 wherein the notification comprises an arrival time at the destination based on the second scheduled route.

13. The item handling system according to any preceding claim wherein the item, after arriving at the destination, is further re-routed to a second destination.

14. The item handling system according to claim 13 wherein the processing means receives details relating to the second destination for the further re-routing from a passenger associated with the item.

15. The item handling system according to any preceding claim wherein the processing means is configured to receive messages relating to one or more factors that caused the item to miss the first predetermined departure time of the first scheduled route and/or one or more parties that are responsible for the one or more factors.

16. The item handling system according to claim 15 comprising a notification system for sending a message to one or more carriers and/or a portable device of a passenger associated with the item, wherein the notification system is configured to send a notification comprising details relating to the factors that caused the item to miss the first predetermined departure time of the first scheduled route and/or one or the more parties that are responsible for the one or more factors.

17. The item handing system according to any preceding claim wherein the second scheduled route between the origin and the determined destination is determined based on one or more parameters comprising at least one of: preferred carrier, departing time, loading capacity, and distance between a current location of the item and a point of departure.

18. The item handling system according to any preceding claim wherein the origin is one of: an airport, a train station, a sea port, and a parcel handling hub.

19. A mobile device for communicating with an item handling system for moving an item between an origin and a destination, wherein if the item handling system determines that the item has been re-routed to a new, second, route to the destination that is different from an original, first, route to the destination, the mobile device is configured to receive a notification from the item handling system, the notification comprising details relating to the second route.

20. The mobile device of claim 19 wherein the notification comprises one or more of: a new departure time from the destination, a new arrival time at the destination, and a new physical path of the second route.

21. The mobile device of claim 19 or 20 wherein the notification comprises one or more factors that caused the item to be re-routed to the new route.

22. The mobile device of claims 19 to 21 wherein the mobile device is configured to receive a user input relating to a further destination for the item to be delivered.

23. A user-accessible device for communicating with an item handling system for moving an item between an origin and a destination, wherein if the item handling system determines that the item has been re-routed to a new, second, route to the destination that is different from an original, first, route to the destination, the user-accessible device being configured to:
i. receive second itinerary data from the item handling system, the second itinerary data comprising details relating to the second route; and
ii. display the second itinerary data to a passenger associated with the item.

24. The user-accessible device of claim 23 wherein the second itinerary data comprises one or more of: a new departure time from the destination, a new arrival time at the destination, and a new physical path of the second route.

25. The user-accessible device of claim 23 or 24 wherein the second itinerary data comprises one or more factors that caused the item to be re-routed to the new route.

26. The user-accessible device of claims 23 to 25 wherein the user-accessible device is configured to receive a user input relating to a further destination for the item to be delivered.

27. The user-accessible device of claims 23 to 26 wherein the user-accessible device is located at the destination.

28. The user-accessible device of claims 23 to 27 wherein the user-accessible device is an electronic board or a kiosk.

29. An item handling system for moving an item between an origin and a destination according to a first scheduled route which departs the origin at a first predetermined departure time, wherein the system comprises:
a. processing means;
b. storage means;
c. a reading means; and
d. at least one conveyor system for conveying the item wherein the processing means is configured to:
i. receive data associated with a tracking means associated with the item;
ii. retrieve a first itinerary data associated with the data associated with the tracking means using the reading means;
iii. determine, based on the first itinerary data, if the item has missed a first predetermined departure time of the first scheduled route;
iv. if it is determined that the item has missed the first predetermined departure time, determine a new, second, route between the origin and the destination;
v. add second itinerary data relating to the determined second scheduled route to the storage means, the second itinerary data comprising: a second predetermined departure time, a departing point within the origin according to the second scheduled route, and a physical path between the origin and destination according to the first scheduled route; and
vi. control the at least one conveyor system to convey the item to the departing point.

30. A method for moving an item between an origin and a destination according to a first scheduled route which departs the origin at a first predetermined departure time, wherein the method comprises steps of:
i. determining whether the item has missed the first predetermined departure time of the first scheduled route;
ii. determining the destination for the item;
iii. determining a new, second, scheduled route between the origin and the determined destination wherein the second scheduled route departs the origin at a second predetermined time which is different from the first predetermined time; and
iv. processing the item according to the second scheduled route.

31. A method for moving an item between an origin and a destination according to a first scheduled route which departs the origin at a first predetermined departure time, wherein the method comprises steps of:
i. receiving data associated with a tracking means associated with the item;
ii. retrieving a first itinerary data associated with the data associated with the tracking means using the reading means;
iii. determining, based on the first itinerary data, if the item has missed a first predetermined departure time of the first scheduled route;
iv. if it is determined that the item has missed the first predetermined departure time, determining a new, second, route between the origin and the destination;
v. adding second itinerary data relating to the determined second scheduled route to a storage means, the second itinerary data comprising: a second predetermined departure time, a departing point within the origin according to the second scheduled route, and a physical path between the origin and destination according to the first scheduled route; and
vi. controlling at least one conveyor system to convey the item to the departing point.
